(19) United States
(12) Patent Application Publication
(10) Pub. No.: US 2006/0240815 A1
(43) Pub. Date: Oct. 26, 2006

(54) Apparatus and method for performing RF calibration in mobile phone

(75) Inventors: Bo-Wook Shim, Seoul (KR); Hong-Woo Lee, Seongnam-si (KR)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignees: Pantech Co., Ltd.; SK Telecom Co., Ltd.

(21) Appl. No.: 11/404,984

(22) Filed: Apr. 14, 2006

(30) Foreign Application Priority Data
Apr. 26, 2005 (KR) 2005-34601

(51) Int. Cl. H04Q 7/20

(52) U.S. Cl. 455/423

(57) ABSTRACT

Disclosed herein is an apparatus and method for performing radio frequency calibration in a mobile phone. The apparatus includes a process control Personal Computer (PC), a base station controller simulator, a switching jig, and a Level Translator (LT). The process control PC performs the overall control of the apparatus for performing RF calibration. The base station controller simulator transmits the RF signals. The switching jig is connected between first and second wireless paths of the diversity mobile communication terminal and the base station controller simulator and is configured to selectively connect the first wireless path and the second wireless path to the base station controller simulator under the control of the process control PC. The LT keeps voltage, which is applied to the diversity mobile communication terminal, constant under the control of the process control PC.

### BACKGROUND OF THE INVENTION

1. Field of the Invention

The present invention relates generally to an apparatus and method for performing radio frequency calibration in a mobile phone and, more particularly, to an apparatus and method for automatically performing radio frequency calibration using a switching jig in the process of producing a mobile communication terminal to which a diversity function is applied.

2. Description of the Related Art

Generally, a mobile communication terminal is used to support a phone call between a sender and a recipient through wireless communication. While electronic components constituting the mobile communication terminal are gradually becoming compact and light, the functions thereof are becoming diverse in order to fulfill customers' demand. For example, mobile communication terminals provided with various functions, such as games, Internet search, the reception and transmission of electronic (e)-mail, and the payment of bills, have been popularized. Recently, mobile communication terminals, which function not only as camera phones that are provided with cameras enabling the capture of still images, but also as video mobile communication terminals that capture moving images and transmit the captured moving images to other persons, are being commercialized.

Such a mobile communication terminal is composed of numerous components. Particularly, although identical components are used for respective reception/transmission Radio Frequency (RF) devices, slight differences in RF characteristics between the components of the respective devices occur. The process of correcting such differences is referred to as RF calibration, and the RF calibration is performed in the state in which a connection between the RF stage of the mobile communication terminal and a base station controller simulator is made.

Meanwhile, a diversity function is used as a method of solving a problem of fading on a communication line, and refers to a function of reducing fading by separating signal transmission paths from each other in terms of space, time, or frequency using two reception antennas, and comparing two received signals with each other, or extracting only appropriate signals from two received signals.

The principle of RF calibration that is performed in a conventional mobile communication terminal having the above-described diversity function (hereinafter a “diversity mobile communication terminal”), and corresponding problems are described below. For reference, an additional wireless path, besides an existing signal transmission path, is provided to the diversity mobile communication terminal in order to implement the diversity function.

FIG. 1 is a block diagram showing the construction of a conventional apparatus for performing RF calibration.

A mobile communication terminal 100 is connected with a base station controller simulator 200 through an RF cable 30, and the base station controller simulator 200 is connected to a process control Personal Computer (PC) 400 using a General-Purpose Interface Bus (GPIB) cable 10. A Level Translator (LT) 300 for keeping voltage, which is applied to the mobile communication terminal 100, constant is connected to the mobile communication terminal 100 and the process control PC 400 through a serial cable 20.

In the conventional apparatus for performing RF calibration, the calibration of a first wireless path RF is performed and then the RF calibration of a second wireless path is performed. The method of performing calibration is described in detail with reference to the flowchart of FIG. 2 below.

First, the reception calibration of a first wireless path is performed at step S210 and, subsequently, the transmission calibration of the first wireless path is performed at step S220. When the RF calibration of the first wireless path is completed, a user personally and manually connects the RF stage of the second wireless path to the base station controller simulator 200 using the RF cable 30. When the second wireless path and the base station controller simulator 200 are connected to each other, the reception calibration of the second wireless path is performed at step S230 and, subsequently, the transmission calibration of the second wireless path is performed at step S240.

In this case, inconvenience occurs in that a single RF cable 30 is used to connect the mobile communication terminal 100 to the base station controller simulator 200, so that a user must personally connect the RF stage of the second wireless path to the RF stage of the base station controller simulator 200 when the RF calibration of the first wireless path is completed.

### SUMMARY OF THE INVENTION

Accordingly, the present invention has been made keeping in mind the above problems occurring in the prior art, and an object of the present invention is to provide an apparatus and method for performing RF calibration, which, when a diversity mobile communication terminal performs RF calibration, automatically switches a wireless path using a switching jig.

In order to accomplish the above object, the present invention provides an apparatus for performing calibration, including a process control PC for performing the overall control of the apparatus for performing RF calibration; a base station controller simulator for transmitting the RF signals; a switching jig connected between first and second wireless paths of the diversity mobile communication terminal and the base station controller simulator, and configured to selectively connect the first wireless path and the second wireless path to the base station controller simulator under the control of the process control PC; and a LT for keeping voltage, which is applied to the diversity mobile communication terminal, constant under the control of the process control PC.

The process control PC controls the switching jig so as to connect the first wireless path of the diversity mobile communication terminal to the base station controller simulator to perform an RF calibration process, and then controls the switching jig so as to connect the second wireless path of the diversity mobile communication terminal to the base station controller simulator to perform the RF calibration process.

The process control PC and the base station controller simulator may be connected to each other through a GPIB cable. The process control PC and the switching jig may be connected to each other through a Universal Serial Bus (USB) cable. The process control PC and the LT are connected to each other through a serial cable.

In addition, a method of performing RF calibration, including the first step of performing RF calibration of a first wireless path in the state in which the first wireless path and the base station controller simulator are connected to each other; the second step of controlling the switching jig so that the second wireless path and the base station controller simulator are connected to each other; and the third step of performing RF calibration of a second wireless path.

The method may further include the step of controlling the switching jig so that the first wireless path and the base station controller simulator are connected to each other, before the first step. The method may further include the step of controlling the switching jig so that the first wireless path and the base station controller simulator are connected to each other, after the third step.

The first step may include the steps of performing reception calibration of the first wireless path; and performing transmission calibration of the first wireless path. In the same manner, the third step may include the steps of performing reception calibration of the second wireless path; and performing transmission calibration of the second wireless path.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing the construction of a conventional apparatus for performing RF calibration;

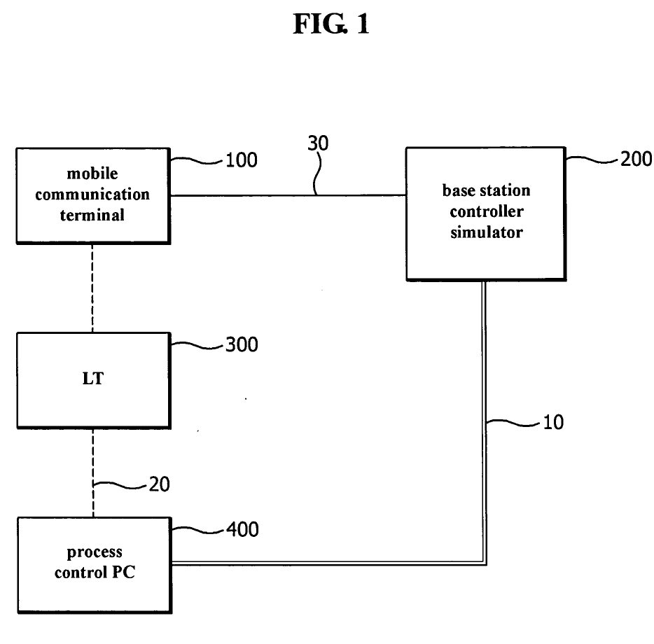

FIG. 2 is a flowchart illustrating a conventional method of performing RF calibration;

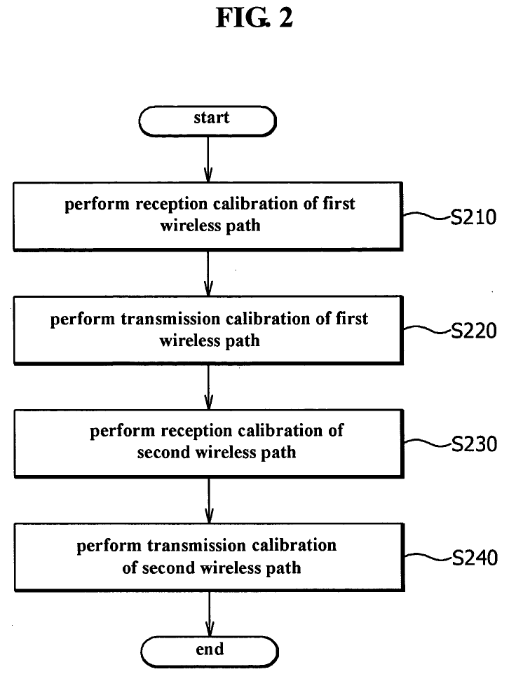

FIG. 3 is a block diagram showing the construction of an apparatus for performing RF calibration according to an embodiment of the present invention; and

FIG. 4 is a flowchart illustrating a method of performing RF calibration according to an embodiment of the present invention.

### DESCRIPTION OF THE PREFERRED EMBODIMENTS

An embodiment of the present invention is described in detail with reference to the accompanying drawings below. It should be noted that the same reference numerals are used throughout the different drawings to designate the same or similar components. If it is determined that detailed descriptions of well-known functions or constructions may be unnecessary and/or make the gist of the present invention unclear, the detailed descriptions will be omitted.

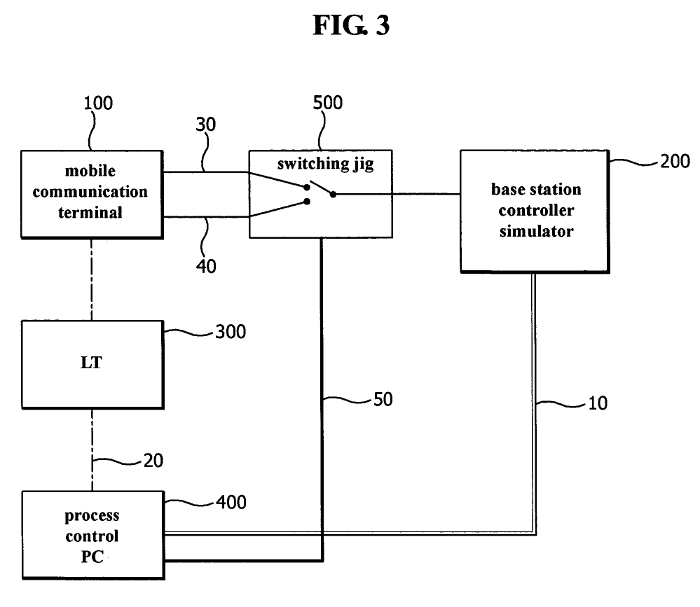

FIG. 3 is a block diagram showing the construction of an apparatus for performing RF calibration according to an embodiment of the present invention. The apparatus for performing RF calibration according to the present invention includes a base station controller simulator 200, an LT 300, a process control PC 400, and a switching jig.

In the diversity mobile communication terminal 100 of the present invention, there are a first wireless path, that is, a main path, and a second wireless path, that is a diversity path. The first and second paths are connected to the switching jig 500 through respective RF cables 30 and 40.

The base station controller simulator 200 transmits an RF signal for RF calibration.

The LT 300 keeps voltage, which is applied to the diversification mobile communication terminal 100, constant under the control of the process control PC 400.

The switching jig 500 is connected between the first wireless path of the diversity mobile communication terminal 100 and the second wireless path of the base station controller simulator 200, and is configured to selectively connect the first wireless path and the second wireless path to the base station controller simulator 200 under the control of the process control PC.

The process control PC 400 performs the overall control of the apparatus of performing RF calibration. A tool for performing RF calibration is installed in the process control PC 400.

In an embodiment of the present invention, the process control PC 400 controls the switching jig 500 so as to connect the first wireless path of the diversity mobile communication terminal 100 to the base station controller simulator 200 to perform an RF calibration process, and then controls the switching jig 500 so as to connect the second wireless path of the diversity mobile communication terminal 100 to the base station controller simulator 200 to perform an RF calibration process.

In FIG. 3, the process control PC 400 and the base station controller simulator 200 are connected to each other using a GPIB cable 10. The process control PC 400 and the switching jig 500 are connected to each other using a USB cable 50. The process control PC 400 and the LT 300 are connected to each other using a serial cable 20.

A method of performing RF calibration using the apparatus for performing RF calibration includes the first step of performing RF calibration of the first wireless path in the state in which the first wireless path and the base station controller simulator 200 are connected to each other, the second step of controlling of the switching jig 500 so that the second wireless path and the base station controller simulator are connected to each other, and the third step of performing RF calibration of the second wireless path, which is described in detail with reference to the accompanying drawings.

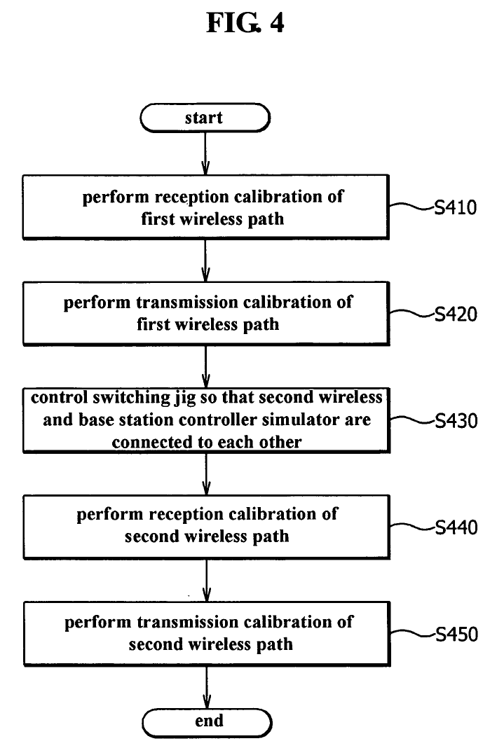

FIG. 4 is a flowchart illustrating the method of performing RF calibration according to an embodiment of the present invention. First, the reception calibration of the first wireless path is performed at step S410. Thereafter, the transmission calibration of the first wireless path is performed at step S420. When the calibration of the first wireless path is completed, the switching jig 500 is controlled such that the second wireless path and the base station controller simulator 200 are connected to each other at step s430. When the second wireless path and the base station controller simulator 200 are connected to each other, the reception calibration of the second wireless path is performed at step S440. Thereafter, the transmission calibration of the second wireless path is performed at step S450.

After the RF calibration is performed through the process, a process of performing initialization so that the first wireless path and the base station controller simulator 200 are connected to each other is necessary. For this purpose, it is necessary controlling the switching jig 500 so that the first wireless path and the base station controller simulator 200 are connected to each other, before the step S410 or after the step S450.

As described above, in accordance with the present invention, switching between wireless paths is performed using the switching jig in the RF calibration process of the diversity mobile communication terminal, so that inconvenience conventionally encountered when a user personally changes the wireless paths can be mitigated, and the diversity mobile communication terminal can be more rapidly and efficiently produced.

Although the preferred embodiment of the present invention has been disclosed for illustrative purposes, those skilled in the art will appreciate that various modifications, additions and substitutions are possible, without departing from the scope and spirit of the invention as disclosed in the accompanying claims.

What is claimed is:

1. An apparatus for performing Radio Frequency (RF) calibration in a diversity mobile communication terminal, the diversity mobile communication terminal including first and second wireless paths for transmitting and receiving RF signals, the apparatus comprising:
a process control Personal Computer (PC) for performing overall control of the apparatus for performing RF calibration;
a base station controller simulator for transmitting the RF signals;
a switching jig connected between the first and second wireless paths of the diversity mobile communication terminal and the base station controller simulator, and configured to selectively connect the first wireless path and the second wireless path to the base station controller simulator under control of the process control PC; and
a Level Translator (LT) for keeping voltage, which is applied to the diversity mobile communication terminal, constant under control of the process control PC.

2. The apparatus as set forth in claim 1, wherein the process control PC controls the switching jig so as to connect the first wireless path of the diversity mobile communication terminal to the base station controller simulator to perform an RF calibration process, and then controls the switching jig so as to connect the second wireless path of the diversity mobile communication terminal to the base station controller simulator to perform the RF calibration process.

3. The apparatus as set forth in claim 1, wherein the process control PC and the base station controller simulator are connected to each other through a General-Purpose Interface Bus (GPIB) cable.

4. The apparatus as set forth in claim 1, wherein the process control PC and the switching jig are connected to each other through a Universal Serial Bus (USB) cable.

5. The apparatus as set forth in claim 1, wherein the process control PC and the LT are connected to each other through a serial cable.

6. A method of performing RF calibration in a diversity mobile communication terminal using a switching jig for selectively connecting a first wireless path and a second wireless path to a base station controller simulator, the diversity mobile communication terminal including the first and second wireless paths for transmitting and receiving RF signals, the method comprising:
the first step of performing RF calibration of the first wireless path in a state in which the first wireless path and the base station controller simulator are connected to each other;
the second step of controlling the switching jig so that the second wireless path and the base station controller simulator are connected to each other; and
the third step of performing RF calibration of the second wireless path.

7. The method as set forth in claim 6, further comprising, before the first step, the step of controlling the switching jig so that the first wireless path and the base station controller simulator are connected to each other.

8. The method as set forth in claim 6, further comprising, after the third step, the step of controlling the switching jig so that the first wireless path and the base station controller simulator are connected to each other.

9. The method as set forth in claim 6, wherein the first step comprises the steps of:
performing reception calibration of the first wireless path; and
performing transmission calibration of the first wireless path.

10. The method as set forth in claim 6, wherein the third step comprises the steps of:
performing reception calibration of the second wireless path; and
performing transmission calibration of the second wireless path.
